(19) United States
(12) Patent Application Publication
(10) Pub. No.: US 2026/0199932 A1
(43) Pub. Date: Jul. 16, 2026

(54) APPLICATOR

(71) Applicant: MITSUBISHI PENCIL COMPANY, LIMITED, Tokyo (JP)

(72) Inventor: Kota FUJIMOTO, Fujioka-shi, Gunma (JP)

(73) Assignee: MITSUBISHI PENCIL COMPANY, LIMITED, Tokyo (JP)

(21) Appl. No.: 19/128,993

(22) PCT Filed: Nov. 28, 2023
(86) PCT No.: PCT/JP2023/042453

§ 371 Date: May 10, 2025

(30) Foreign Application Priority Data
Nov. 30, 2022 (JP) 2022-191018

(51) Int. Cl. B05C 17/005

(52) U.S. Cl. CPC B05C 17/00583; B05C 17/0052

(57) ABSTRACT

The applicator includes a coating liquid tank that is a flexible container; a front barrel; an application portion; and a valve mechanism communicating the coating liquid tank and the application portion. The valve mechanism includes an intake valve and a liquid discharge valve. A valve rod and a second valve container are provided in the intake valve mechanism. When an inside of the coating liquid tank is at a negative pressure, intake of air can be performed through a gap between the valve rod and the second valve container. The intake valve mechanism and a first valve container are provided in the liquid discharge valve mechanism. A coating liquid can flow through a gap between the intake valve mechanism and the first valve container when the inside of the coating liquid tank is at a positive pressure.

### TECHNICAL FIELD

The present invention relates to an applicator for supplying a coating liquid in an ink tank to an application portion.

### BACKGROUND ART

Patent Document 1 discloses an applicator provided with a pen-tip pressing type valve mechanism. In many applicators of this type, when the tip of the application body is pressed against the application surface, the application body is retracted to open the valve.

However, when the operation of pressing the tip of the application body against the application surface is repeated, there is a problem that the tip of the application body is deformed and accurate application cannot be performed.

In particular, when the application portion is a brush, the brush is weak and the valve mechanism is difficult to operate by pressing from the front, and these applicators are not suitable for application to the brush.

Therefore, an applicator using a valve mechanism that opens by increasing the internal pressure of a coating liquid tank as described in Patent Document 2 has been considered instead of an applicator using a valve mechanism that opens by pressing an application portion as described in Patent Document 1.

### CITATION LIST

### Patent Document

Patent Document 1: JP 2001-63276 A
Patent Document 2: Utility Model JP H6-3686 A

### SUMMARY OF INVENTION

### Technical Problem

However, in the applicator using the valve mechanism which opens the valve by increasing the internal pressure of the coating liquid tank, when the internal pressure is decreased by releasing the pressing force of the coating liquid tank or the like after the internal pressure is increased to discharge the coating liquid, the internal pressure of the coating liquid tank becomes a negative pressure. In this case, there is a problem that the valve mechanism does not work and air replacement is not possible.

The present invention has been made in view of the above circumstances, and an object of the present invention is to provide an applicator capable of performing air replacement after discharge of a coating liquid even when the applicator is provided with a valve mechanism for increasing the internal pressure of a coating liquid tank to open the valve.

### Solution to Problem

According to the present invention, there is provided an applicator including a coating liquid tank that is a flexible container deformed when pressed by a finger of a user; a front barrel fixed to the coating liquid tank and including a discharge port configured to discharge a coating liquid; an application portion fixed to the front barrel; and a valve mechanism communicating the coating liquid tank and the application portion, wherein the valve mechanism includes at least two valve mechanisms of an intake valve and a liquid discharge valve, a valve rod and a second valve container are provided in the intake valve mechanism, and intake of air can be performed through a gap between the valve rod and the second valve container when an inside of the coating liquid tank is at a negative pressure, and the intake valve mechanism and a first valve container are provided in the liquid discharge valve mechanism, and a coating liquid can flow through a gap between the intake valve mechanism and the first valve container when the inside of the coating liquid tank is at a positive pressure.

In the present invention, it is preferable that the liquid discharge valve mechanism includes a first spring configured to urge a gap between the second valve container and the first valve container to be closed, the intake valve mechanism includes a second spring configured to urge a gap between the valve rod and the second valve container to be closed, and an urging force of the second spring is set to operate at least at atmospheric pressure.

In the present invention, it is preferable that the valve mechanism includes the first spring, the second valve container, and the valve rod coaxially disposed in the first valve container.

In the present invention, it is preferable that the applicator includes a storage body in the front barrel and has a function of suppressing a flow of a coating liquid discharged from the valve mechanism and suppressing an amount of a coating liquid flowing to the application portion.

In the present invention, it is preferable that a stirring rod slidable in a front-rear direction is disposed in front of a coaxial line of the valve rod of the liquid discharge valve mechanism, and the stirring rod is contactable with the valve rod.

### Advantageous Effects of Invention

According to the applicator of the present invention, the valve mechanism includes at least two valve mechanisms of an intake valve and a liquid discharge valve. The intake valve mechanism allows intake of air through a gap between the valve rod and the second valve container when an inside of a coating liquid tank is at a negative pressure, and a liquid discharge valve mechanism allows a coating liquid to flow through a gap between the second valve container and a first valve container when an inside of the coating liquid tank is at a positive pressure. Thus, when the coating liquid tank becomes negative pressure after the coating liquid flows out, the intake valve mechanism opens to replace the air, thereby reliably preventing the inside of the coating liquid tank from remaining in a negative pressure state after the coating liquid flows out.

Therefore, this has the excellent effect that when the applicator is used, the coating liquid tank does not remain at a negative pressure in the operation of discharging the coating liquid, and a problem such as a failure in discharging the coating liquid can be solved.

### BRIEF DESCRIPTION OF DRAWINGS

FIG. 1 is an overall explanatory view of an applicator according to an embodiment of the present invention, in which (a) is an external view and (b) is a longitudinal cross-sectional view of (a),

FIG. 2 is an explanatory view illustrating a state when the barrel is pressed and the intake valve mechanism is advanced in the applicator of FIG. 1, in which (a) is an external view and (b) is a longitudinal cross-sectional view of (a).

FIG. 3 is an explanatory view illustrating a state in which the valve of the intake valve mechanism is opened when the pressure on the barrel is released and the intake valve mechanism is retracted in the applicator of FIG. 1, in which (a) is an external view and (b) is a longitudinal cross-sectional view of (a).

FIG. 4 is a detailed longitudinal cross-sectional view of a valve mechanism constituting the applicator of FIG. 1.

FIG. 5 is a longitudinal cross-sectional view of the valve mechanism in the applicator of FIG. 1 when the barrel is pressed and the intake valve mechanism is advanced.

FIG. 6 is a cross-sectional view of the valve mechanism in the applicator of FIG. 1 when the pressure on the barrel is released and the intake valve mechanism is retracted.

FIG. 7 is a detailed longitudinal cross-sectional view of an intake valve mechanism constituting the valve mechanism.

FIG. 8 is a detailed cross-sectional view of a valve mechanism according to a first modified example in the applicator of the embodiment.

FIG. 9 is a longitudinal cross-sectional view of the valve mechanism according to the first modified example in the applicator of the embodiment when the barrel is pressed and the intake valve mechanism is advanced.

FIG. 10 is a cross-sectional view of the valve mechanism according to the first modified example in the applicator according of embodiment when the pressure on the barrel is released and the intake valve mechanism is retracted.

FIG. 11 is an overall explanatory view of an applicator according to a second modified example in the applicator of the embodiment, in which (a) is an external view and (b) is a longitudinal cross-sectional view of (a).

FIG. 12 is a detailed cross-sectional view of a valve mechanism according to the second modified example in the applicator of the embodiment.

### DESCRIPTION OF EMBODIMENTS

Embodiments of the present invention will be described below with reference to appended drawings.

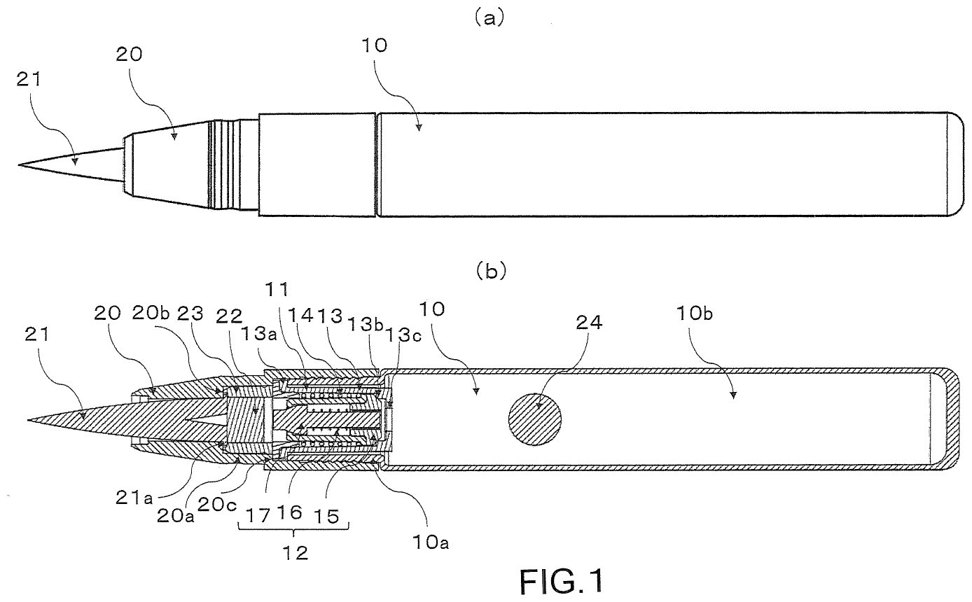

FIGS. 1 to 3 are overall explanatory views of an applicator according to an embodiment.

As illustrated in FIG. 1, the applicator is an applicator provided with a valve mechanism 11 for communicating a coating liquid tank 10 and an application portion 21.

The valve mechanism 11 includes two valve mechanisms of an intake valve and a liquid discharge valve.

The liquid discharge valve mechanism includes a second valve container 15, a first valve container 13 and a first spring 14, When the internal pressure of the coating liquid tank 10 becomes a positive pressure more than the outside, the first spring 14 is elastically deformed, and the coating liquid can flow through a gap between the second valve container 15 and the first valve container 13.

An intake valve mechanism 12 includes a valve rod 17, the second valve container 15 for housing the valve rod 17, and a second spring 16. When the coating liquid tank 10 side becomes a negative pressure more than the application portion 21 side, the second spring 16 is elastically deformed, and the intake valve mechanism 12 can take in air from a gap between the valve rod 17 and the second valve container 15.

Hereinafter, each portion will be described in detail.

### Coating Liquid Tank 10

The coating liquid tank 10 is a barrel integrated with an outer peripheral wall from a central portion to a rear portion, and the coating liquid tank 10 has a function of changing an internal pressure by deformation of the barrel in a radial direction to make the coating liquid flow out.

A front end portion 10a of the coating liquid tank 10 has a smaller diameter than a main body 10b, the rear portion of a front barrel 20 is externally fitted thereto, and the main body 10b is a flexible container.

Specifically, the coating liquid tank 10 is a blow-molded resin container, and is a flexible container set thick and thus the container is elastically deformed when pressed in the radial direction by a user's finger to increase the internal pressure in the tank. The coating liquid tank 10 is a barrel which is held by a user's hand to perform a coating operation, and when it is necessary to supply the coating liquid, the coating liquid tank 10 can be pressed and deformed in the radial direction by a finger to reduce an internal volume, thereby increasing an inner pressure.

The coating liquid tank 10 may be made of a resin material such as PP (polypropylene), PE (polyethylene), PS (polystyrene), PET (polyethylene terephthalate), PC (polycarbonate), PA (polyamide), POM (polyacetal), PES (polyether sulfone), PEN (polyethylene naphthalate), vinyl chloride, EVOH (ethylene-vinyl alcohol copolymer resin), PBT (polybutylene terephthalate), or ABS (acrylonitrile-butadiene-styrene copolymer synthetic resin), or a metal material such as stainless steel, iron, brass, copper, or aluminum, and may be formed by one or a combination of resin molding methods such as blow molding, vacuum forming, or injection molding, or metal processing methods such as cutting, drawing, or press molding, or by bonding, welding, sewing, or the like, a thin film material such as a resin film or a metal foil into a sealed bag shape.

### Front Barrel 20

The front barrel 20 has a front portion formed in a tapered shape, is formed in a hollow shape (mounting hole 20a) in a substantially tubular shape, and internally houses the application portion 21 in such a manner that the tip thereof is exposed.

A flange 21a enlarged in diameter at the rear end portion of the application portion 21 is locked to a front stepped portion 20b in the front barrel 20 to be prevented from coming off. In the mounting hole 20a, a storage body receiving member 23 for housing a storage body 22 for the coating liquid is mounted on the rear surface of the flange 21a.

### Storage Body 22

The storage body 22 is housed in the storage body receiving member 23 mounted in the mounting hole 20a formed in the front barrel 20, and has a function of suppressing the flow of the coating liquid discharged from the valve mechanism 11 and suppressing the amount of the coating liquid flowing to the application portion 21.

The storage body 22 may be made of a so-called sponge material such as a fiber bundle of natural fibers or synthetic resin fibers, a fiber bundle body obtained by processing a fiber bundle of felt or the like, or a resin particle porous body made of a hard sponge or a resin particle sintered body.

### Valve Mechanism 11

As illustrated in FIG. 1, the valve mechanism 11 includes, as a liquid discharge valve mechanism, (the second valve container 15 constituting a part of) the intake valve mechanism 12, the first valve container 13 housing the intake valve mechanism 12 therein, and the first spring 14 urging the intake valve mechanism 12 rearward with respect to the first valve container 13.

A flange-shaped front end portion 13a of the first valve container 13 is sandwiched and fixed between a rear stepped portion 20c of the front barrel 20 and the front end portion 10a of the coating liquid tank 10.

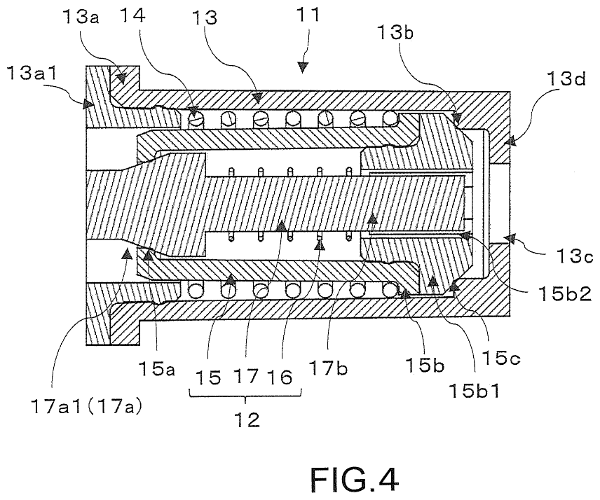

Specifically, as illustrated in FIG. 4, an annular collar 13al is fitted and fixed to and integrated with the front end portion 13a of the first valve container 13 to be positioned from the front end surface to the inner surface. A clearance through which a liquid can flow is provided between an inner peripheral surface of the collar 13a1 and an outer peripheral surface of the second valve container 15, and the second valve container 15 is slidably inserted into the collar 13a.

The first valve container 13 is a substantially cylindrical body in which the inner periphery of the rear portion is smaller in diameter than that of the front portion via a stepped portion 13b, and a flow hole 13c is opened in a wall portion 13d at the rear end, and thus discharged liquid and intake air can flow between the first valve container 13 and the coating liquid tank 10 via the flow hole 13c.

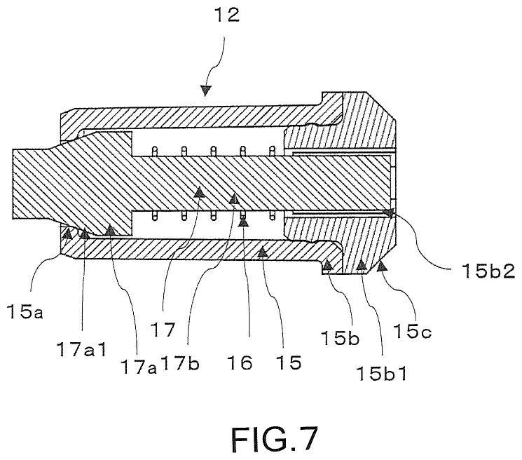

As illustrated in FIGS. 4 and 7, the intake valve mechanism 12 includes the valve rod 17, the second valve container 15 that houses the valve rod 17, and the second spring 16 that urges the valve rod 17 forward with respect to the second valve container 15.

The rear end of the second valve container 15 is a substantially cylindrical body (partially closed by a guide member 15b1), and an intake air flow hole 15a is formed on the side surface side of the front portion, and a rearward inclined surface 15c (a tapered surface which becomes thinner toward the rear) is formed on the outer peripheral portion of a flange 15b. The open lid-like guide member 15b1 is fitted into and integrated with the flange 15b from the rear end surface to the inner surface of the second valve container 15.

A shaft portion 17b of the valve rod 17 is slidably fitted into the inner periphery of an opening 15b2 of the guide member 15b1, and the inclined surface 15c is formed on the rear end surface of the guide member 15b1. A clearance allowing intake air to flow is provided between the inner peripheral surface of the opening 15b2 of the guide member 15b1 and the outer peripheral surface of the shaft portion 17b.

The valve rod 17 is a substantially rod-shaped body in which an annular convex portion 17a having a forward inclined surface (a tapered surface that becomes thinner toward the front) 17al on the outer peripheral surface is formed at the front portion to bulge out to have a larger diameter than the rod-shaped shaft portion 17b at the rear portion.

The intake air flow hole 15a of the second valve container 15 is formed on a forwardly inclined surface of the inner periphery of the opening formed in the wall-like portion at the front end of the second valve container 15, and an intake path (air replacement path) is formed in a gap between the inclined surface of the inner periphery of the opening and the inclined surface of the outer periphery of the annular convex portion 17a of the valve rod 17.

The coiled resinous or metallic first spring 14 is interposed between the front surface of the flange 15b of the second valve container 15 and the rear end surface of the front portion (collar 13a1) of the first valve container 13, and the first spring 14 urges the intake valve mechanism 12 (the second valve container 15, the valve rod 17, and the second spring 16) rearward. The urging force maintains the contact force between the rearward inclined surface 15c of (the guide member 15b1 of) the flange 15b and the front inner surface of the stepped portion 13b.

The coiled resinous or metallic second spring 16 is interposed between the rear surface portion of the annular convex portion 17a reduced in diameter in a stepped manner and the front surface of the rear portion (guide member 15b1) of the second valve container 15, and the valve rod 17 is urged forward by the second spring 16. The urging force maintains the contact force between the forward inclined surface 17al of the annular convex portion 17a and the front inner surface of the intake air flow hole 15a (inclined surface of the opening).

The operation of the applicator according to the embodiment will be described,

### [When the Coating Liquid Tank 10 is Pressed, Deformed, and Pressurized]

Since the coating liquid tank 10 is a blow-molded flexible resin container, it has a cylindrical shape as illustrated in FIG. 1 in a state where no force is applied.

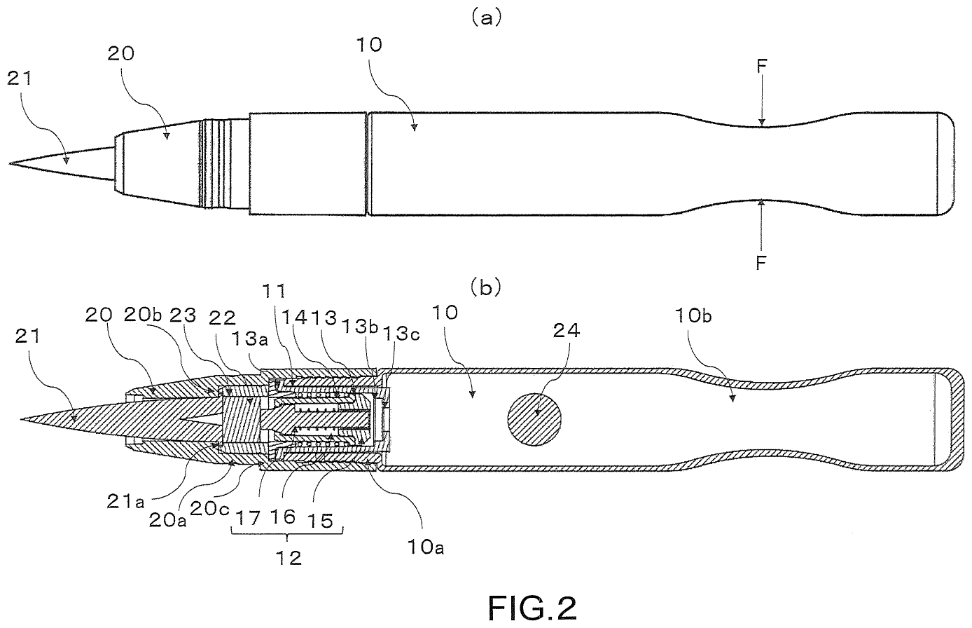

As illustrated in FIG. 2, when a user of the applicator applies a radial force (indicated by reference numeral F) to the coating liquid tank 10 with his/her fingers, the coating liquid tank 10 is elastically deformed to reduce its internal volume, and thus its internal pressure becomes higher than the outside air.

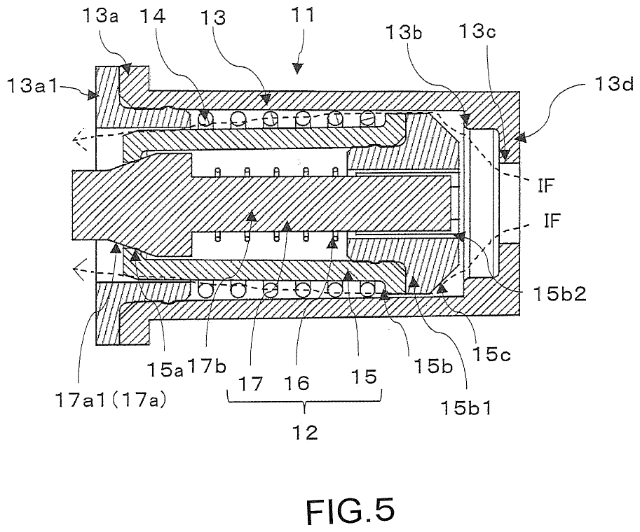

Due to the pressure difference, a force for moving the intake valve mechanism 12 in the valve mechanism 11 forward is generated. When the force exceeds the urging force of the first spring 14, as illustrated in FIG. 5, the intake valve mechanism 12 moves forward, and the rearward inclined surface 15c of the flange 15b of the intake valve mechanism 12 moves away from the stepped portion 13b of the first valve container 13 to open the valve.

Therefore, in the valve mechanism 11, as illustrated in FIGS. 2 and 5, when the valve is opened, the coating liquid flows through the flow hole 13c and the gap between the rearward inclined surface 15c of the flange 15b and the stepped portion 13b (the coating liquid flowing is illustrated by a broken line IF in FIG. 5). When the coating liquid flows forward and the internal pressure of the tank is released, the intake valve mechanism 12 of the valve mechanism 11 is moved rearward by the urging force of the first spring 14, and the rearward inclined surface 15c of the flange 15b of the intake valve mechanism 12 is brought into contact with the stepped portion 13b of the first valve container 13 to close the valve.

### [When the Pressing to the Coating Liquid Tank 10 is Stopped and the Deformation is Going to Return to the Original State]

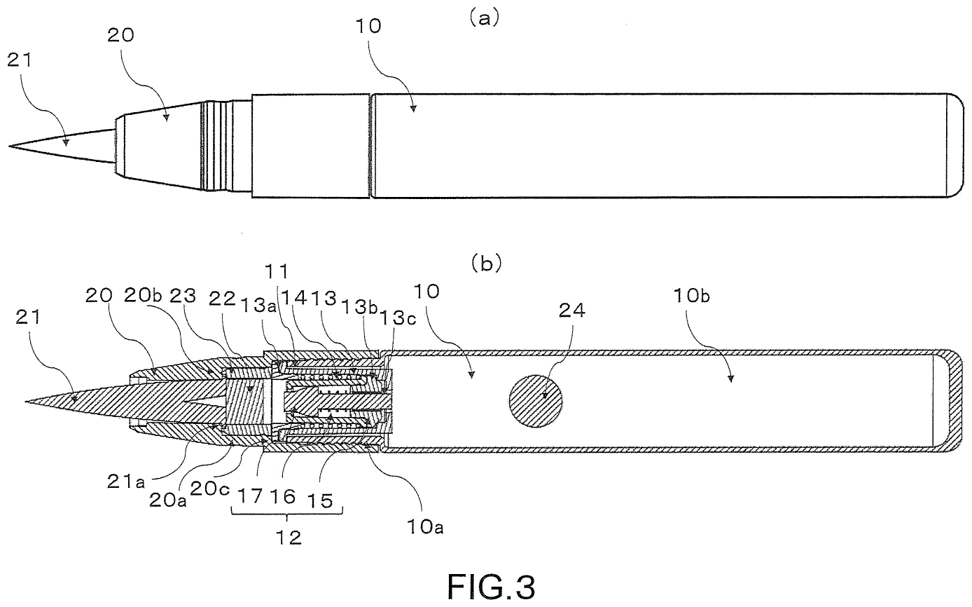

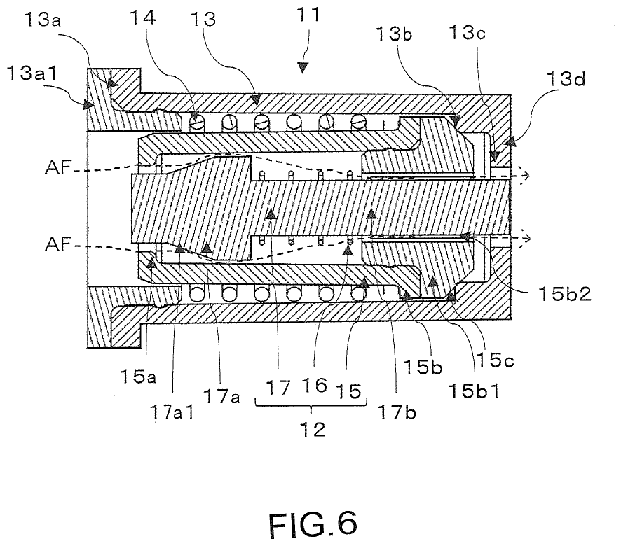

As illustrated in FIG. 3, when the pressurizing force applied to the coating liquid tank 10 is released by loosening the force of the fingers, the elastic deformation of the coating liquid tank 10 is going to return to the original state and the internal volume is going to increase, and thus the internal pressure becomes a negative pressure lower than the outside air. The pressure difference generates a force to move the valve rod 17 in the intake valve mechanism 12 rearward. When the force exceeds the urging force of the second spring 16, as illustrated in FIGS. 3 and 6, the valve rod 17 moves rearward, and the annular convex portion 17a of the valve rod 17 is separated from the front inner surface of the intake air flow hole 15a of the second valve container 15 to open the valve.

Therefore, the coating liquid tank 10 performs air replacement via the intake valve mechanism 12.

When the valve of the intake valve mechanism 12 is opened, air passes through the intake air flow hole 15a, passes through a gap between the annular convex portion 17a and the intake air flow hole 15a, and enters the coating liquid tank 10 (in FIG. 6, the flowing air (replacement) is indicated by a broken line with reference numeral AF).

When air enters the coating liquid tank 10 and there is no difference between the internal and external pressures, the valve rod 17 of the intake valve mechanism 12 is moved forward by the urging force of the second spring 16, and the annular convex portion 17a of the valve rod 17 comes into contact with the intake air flow hole 15a of the second valve container 15 to close the valve (the state illustrated in FIGS. 1 and 4).

According to the embodiment, since the valve mechanism 11 allows the coating liquid to flow through the gap between the intake valve mechanism 12 and the first valve container 13 and the intake valve mechanism 12 allows the intake through the gap between the valve rod 17 and the second valve container 15, the intake valve mechanism 12 is opened to replace air when the coating liquid tank 10 becomes negative pressure after the coating liquid flows out, and thus, after the coating liquid flows out, the negative pressure in the coating liquid tank 10 is released, and the negative pressure state can be reliably prevented from being maintained.

Since the valve rod 17 and the second valve container 15 are provided in the intake valve mechanism 12 and the intake valve mechanism 12 and the first valve container 13 are provided in the liquid discharge valve mechanism, the entire valve mechanism 11 is integrated in one place and the length of the valve mechanism 11 in the front-rear direction can be shortened, and thus the entire applicator does not become long, allowing for high design freedom and making it easy to be made compact.

Since the first spring 14, the second valve container 15, and the valve rod 17 are coaxially disposed in the first valve container 13, the length of the valve mechanism 11 in the front-rear direction can be further shortened, and the applicator can be easily made compact.

### Valve Mechanism According to First Modified Example

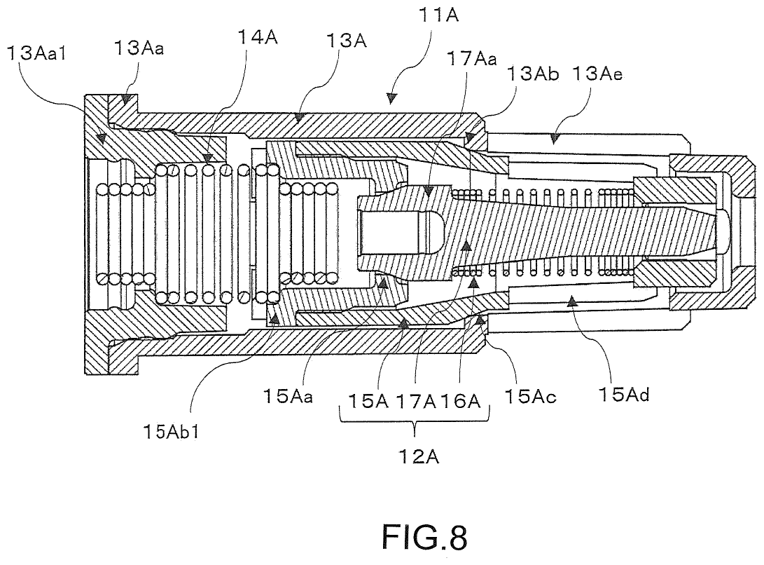

The valve mechanism is not limited to the embodiment, and may be a valve mechanism 11A as in a first modified example illustrated in FIG. 8.

As illustrated in FIG. 8, the valve mechanism 11A according to the first modified example includes, as the liquid discharge valve mechanism, (a second valve container 15A constituting a part of) an intake valve mechanism 12A, a first valve container 13A housing the intake valve mechanism 12A therein, and a first spring 14A urging the intake valve mechanism 12A rearward with respect to the first valve container 13A.

Specifically, as illustrated in FIG. 8, an annular collar 13Aa1 is fitted and fixed to and integrated with a front end portion 13Aa of the first valve container 13A to be positioned inward from the front end surface. An annular convex portion is formed on and protruding from the inner surface of the collar 13Aa1, An annular collar 15Ab1 is fitted into the inside from the front end surface of the second valve container 15A to be integrated therewith. The first spring 14A is interposed between the inner peripheral convex portion of the collar 13Aa1 and the front end concave portion of the collar 15Ab1, and the second valve container 15A is resiliently urged rearward with respect to the first valve container 13A by the resilient force of the first spring 14A.

The intake valve mechanism 12A includes a valve rod 17A, the second valve container 15A housing the valve rod 17A, and a second spring 16A urging the valve rod 17A forward with respect to the second valve container 15A. A clearance through which the coating liquid flows is provided between the inner peripheral surface of the first valve container 13A and the outer peripheral surface of the second valve container 15A. At the rear portions of the first valve container 13A and the second valve container 15A forming the valve mechanism 11A, an opening portion 13Ae and an opening portion 15Ad are respectively opened to face the inside of the coating liquid tank. The opening portion 13Ae and the opening portion 15Ad allow the coating liquid and air to flow inside the valve mechanism 11A and the coating liquid tank 10 (see FIGS. 1 and 2).

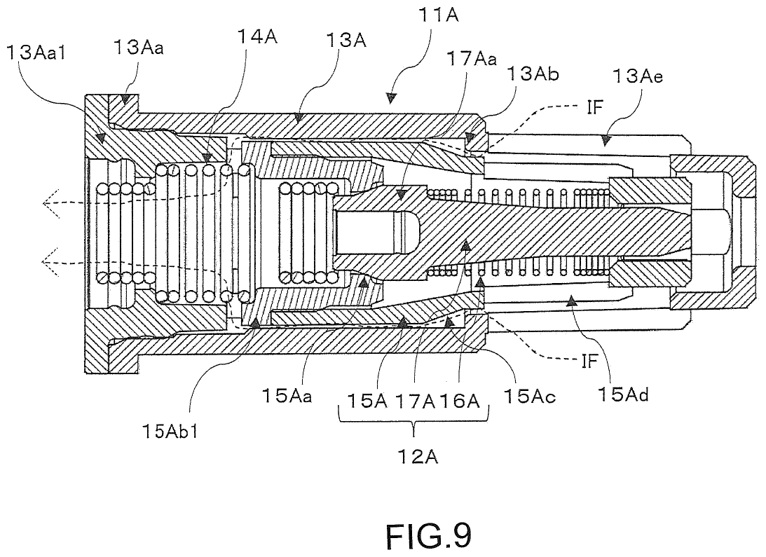

In a state where the barrel (coating liquid tank 10) is pressed to pressurize the interior of the barrel as illustrated in FIG. 2, a force is generated to move the intake valve mechanism 12A in the valve mechanism 11A illustrated in FIG. 8 forward, by the pressure difference. When the force exceeds the urging force of the first spring 14A, as illustrated in FIG. 9, the intake valve mechanism 12A moves forward, and a rearward inclined surface 15Ac of the intake valve mechanism 12A moves away from a stepped portion 13Ab of the first valve container 13A to open the valve.

Therefore, in the valve mechanism 11A, as illustrated in FIG. 9, when the valve is opened, the coating liquid flows through the gap between the rearward inclined surface 15Ac and the stepped portion 13Ab (in FIG. 9, the flowing coating liquid is indicated by a broken line with reference numeral IF).

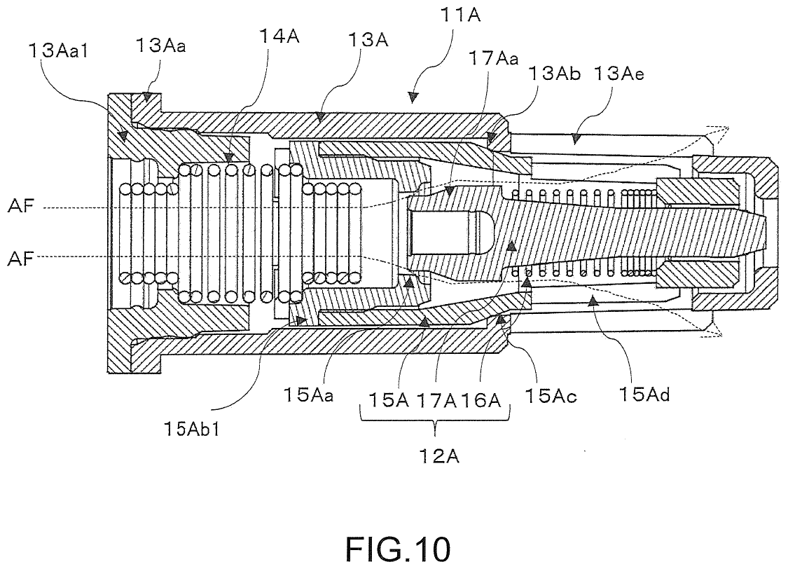

As illustrated in FIG. 3, in a state where the pressurizing force applied to the coating liquid tank 10 is released by loosening the force of the fingers, a force for moving the valve rod 17A in the intake valve mechanism 12A illustrated in FIG. 8 rearward is generated by the difference in pressure (negative pressure). When the force exceeds the urging force of the second spring 16A, as illustrated in FIG. 10, the valve rod 17A moves rearward, and an annular convex portion 17A of the valve rod 17A is separated from the inner surface of the front side of an intake air flow hole 15Aa of the second valve container 15A to open the valve.

Therefore, the coating liquid tank 10 performs air replacement via the intake valve mechanism 12A (the air (replacement) flowing in FIG. 10 is indicated by a broken line denoted by reference numeral AF).

Since the first valve container 13A and the second valve container 15A forming the valve mechanism 11A are formed with the opening portion 13Ae and the opening portion 15Ad, respectively, and the space in the valve mechanism is open to the outside, it is easy to stir the sediment or the like of the content liquid components accumulated in the valve when the pen body is stored in the downward direction, and it is possible to prevent the poor sliding of the valve or the like due to the sticking of the sediment or the like.

Note that it is apparent that the above-described embodiment is merely an example of the present invention and can be freely changed within the scope of the present invention.

### Valve Mechanism According to Second Modified Example

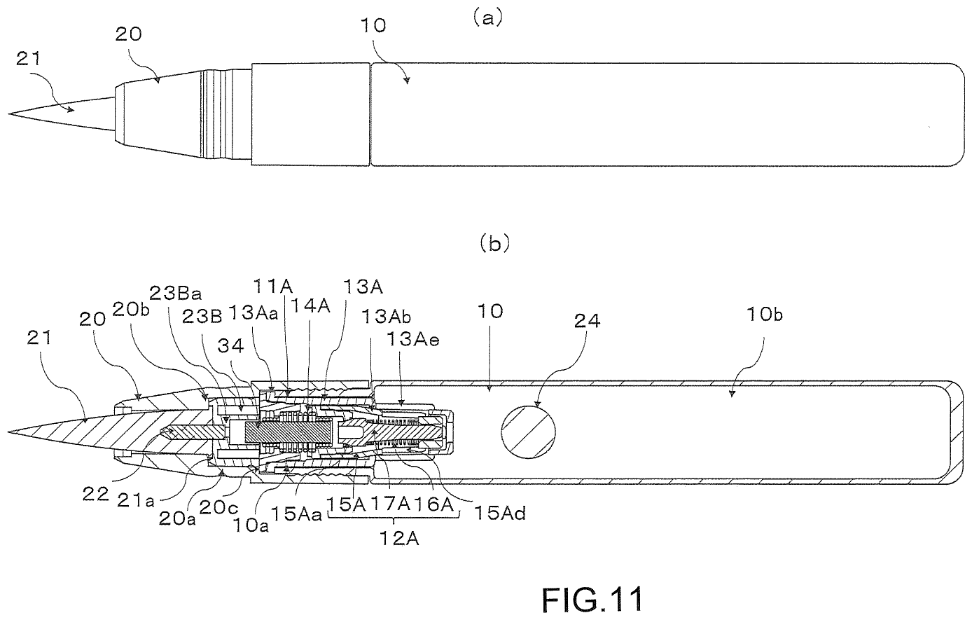

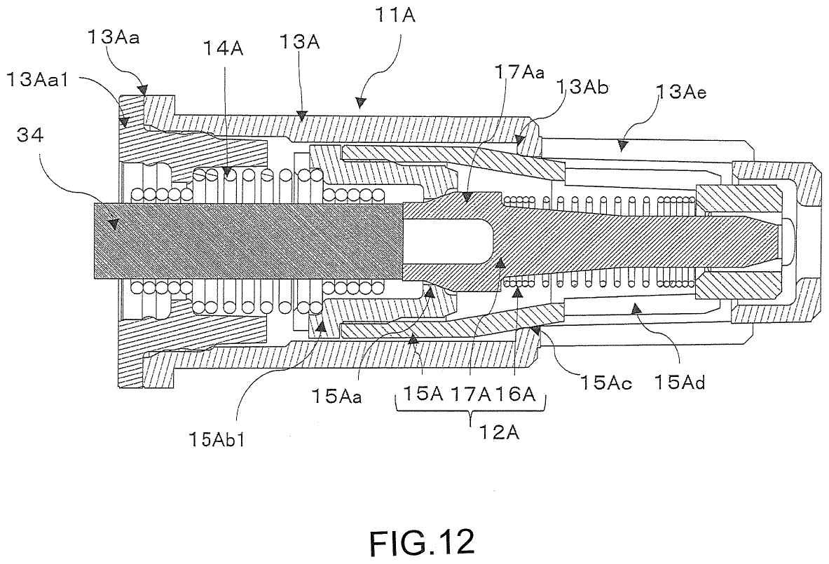

The valve mechanism is not limited to the embodiment, and may be a valve mechanism as in a second modified example illustrated in FIGS. 11 and 12. In the second modified example, the same portions as those of the embodiment and the first modified example are denoted by the same reference numerals.

FIG. 11 are an overall view and a cross-sectional view of the second modified example. FIG. 12 is a detailed cross-sectional view of the valve mechanism 11A.

As illustrated in FIG. 11, in the second modified example, unlike the embodiment illustrated in FIGS. 1 to 3, the front end of the storage body 22 of the coating liquid is inserted from the rear surface of the flange 21a, and the rear end of the storage body 22 is inserted into a through hole 23Ba formed on the front side of a storage body receiving member 23B that houses the storage body 22.

In the second modified example, as illustrated in FIGS. 11 and 12, the valve mechanism 11A has a structure in which a stirring rod 34 is added to the first modified example.

As illustrated in FIG. 11, the stirring rod 34 is disposed in a space extending from the inside of the rear portion side of the through hole 23Ba in the storage body receiving member 23B to the inner surface side of the spring 14A in the valve mechanism 11A. By the stirring rod 34, it is possible to improve the coating property of the coating liquid having a large particle diameter and to prevent the malfunction of the valve mechanism 11 due to the sticking of the coating liquid by the deposit from the intake air flow hole 15Aa to the opening portion 15Ad of the coating liquid. By disposing the stirring rod 34 on the front side of the valve rod 17A, by performing stirring operation in the front-rear direction of the axis before use, the stirring rod 34 gives impact by collision with the front end surface of the valve rod 17A, thereby separating the fixed valve rod 17A and the intake air flow hole 15Aa to make the valve mechanism 11A function.

The material of the stirring rod 34 is not particularly specified as long as the valve rod 17 can be moved by the stirring operation, but austenitic stainless steel which has a high specific gravity and is hard to be corroded by the coating liquid and has little influence on the coating liquid is preferable.

As described above, the coating liquid used in the second modified example is preferably a coating liquid having a particularly large particle diameter. An example of the coating liquid having a large particle diameter is a cosmetic containing titanium oxide having at least an average particle diameter of 0.2 μm or more and resin fine particles having an average particle diameter of 0.01 to 100 μm.

More specifically, the average particle diameter of the titanium oxide is preferably 0.2 μm or more from the viewpoints of whiteness and hiding properties. Note that titanium oxide having an average particle diameter of less than 0.2 μm is not preferable because the whiteness and hiding power are deteriorated.

Note that the “average particle diameter” means a primary average particle diameter and is a value measured on the basis of an electron micrograph.

The content of titanium oxide is preferably 1 to 40 mass % by mass (hereinafter, simply referred to as “%”) with respect to the total amount of the cosmetic from the viewpoint of imparting whiteness and hiding power. When the content of the titanium oxide is less than 1%, the whiteness and the hiding power are deteriorated, and on the other hand, when the content is more than 40%, the fluidity and the sense of use of the cosmetic are deteriorated, which is not preferable.

When the average particle diameter of the resin fine particles that can be used is in the range of 0.01 to 100 μm, the interaction with the titanium oxide having an average particle diameter of 0.2 μm or more can suppress the content of titanium oxide and reduce troubles due to precipitation at the same solid content as that of titanium oxide alone, not affecting the sense of use of various cosmetics, and highly imparting higher whiteness and hiding power. Note that when the average particle diameter of the resin fine particles to be used is less than 0.01 μm or more than 100 μm, the effect cannot be exhibited, and the hiding power becomes insufficient or the finish becomes poor. Further, when the resin fine particles described above are hollow particles, the effects of higher whiteness, higher hiding power, and higher drying rate can be exhibited.

The resin fine particles that can be used are preferably (styrene/acrylates) copolymers and (acrylates/maleic acid/styrene) copolymers from the viewpoint of highly imparting higher whiteness and hiding power by interaction with titanium oxide.

The content (solid content concentration) of these resin fine particles is preferably 1 to 50% with respect to the total amount of the cosmetic from the viewpoint of exhibiting whiteness and hiding power. When the content of the resin particles is less than 1%, whiteness and hiding power cannot be exhibited, and on the other hand, when it exceeds 50%, the fluidity of the cosmetic is deteriorated.

The cosmetic contains the titanium oxide and the resin fine particles described above, and may further contain a film forming resin, a thickener, and a coloring agent from the viewpoint of the use of the cosmetic, a suitable blending composition, and the like.

The film forming resin is not particularly limited as long as it is a film forming resin used in various cosmetics. The content (solid content concentration) of the film forming resin is preferably 0.1 to 30% relative to the total amount of the cosmetic.

As the coloring agent, an organic pigment, an inorganic pigment, a pearl pigment, other bright pigments, and a dye which are generally used in cosmetics can be used, but a dye is preferably used from the viewpoint of utilizing high whiteness and hiding power. The content of the coloring agent varies depending on the use of the cosmetic, and is preferably 0.001 to 10% with respect to the total amount of the cosmetic.

As the thickener, a thickener generally used in cosmetics can be used. The content of the thickener is preferably 0.001 to 10% with respect to the total amount of the cosmetic.

The remainder may contain water (purified water, distilled water, ion-exchanged water, pure water, or the like), and further, for the purpose of adjusting the drying property, a water-soluble organic solvent and other optional components such as a pH adjusting agent, a neutralizing agent, an ultraviolet absorber, an ultraviolet scattering agent, a wax, a surfactant, a humectant, a perfume, an antioxidant, a preservative, a sequestering agent, an antifoaming agent, various kinds of extracts and other various kinds of components can be appropriately blended as necessary. It is particularly desirable to use an organic solvent, and the content thereof is preferably 0.001 to 20% with respect to the total amount of the cosmetic in order to obtain suitable drying property.

The viscosity of the cosmetic as the coating liquid of the embodiment at a shear rate of 3.83 (s−1) at 25° C. is preferably 10 (mPa·s) to 1000 (mPa·s) from the viewpoint of usability and hiding power after applied, although the viscosity varies depending on the application of the cosmetic. When the viscosity is less than 10 (mPa·s), titanium oxide is more likely to form a deposit from the intake air flow hole 15Aa to the opening portion 15Ad of the coating liquid in the valve mechanism 11, and the intended property may not be obtained.

Note that the above-described cosmetic material is an example of the coating liquid according to the present invention, and can be freely modified within the scope of the present invention.

### INDUSTRIAL APPLICABILITY

The applicator of the present invention can be used as various applicators such as writing instruments, cosmetics, and paints. In particular, the present invention is suitable for an applicator using a thin pen core or a soft brush which is difficult to pump at the pen tip.

### REFERENCE SIGNS LIST

10 Coating liquid tank
11 Valve mechanism
11A Valve mechanism (first modified example)
12 Intake valve mechanism
12A Intake valve mechanism (first modified example)
13 First valve container
13A First valve container (first modified example)
14 First spring
14A First spring (first modified example)
15 Second valve container
15A Second valve container (first modified example)
16 Second spring
16A Second spring (first modified example)
17 Valve rod
17A Valve rod (first modified example)
20 Front barrel
21 Application portion
22 Storage body
23 Storage body receiving member
23B Storage body receiving member (second modified example)
24 Stirring ball
34 Stirring rod (second modified example)

1. An applicator comprising:
a coating liquid tank that is a flexible container deformed when pressed by a finger of a user;
a front barrel fixed to the coating liquid tank and including a discharge port configured to discharge a coating liquid;
an application portion fixed to the front barrel; and
a valve mechanism communicating the coating liquid tank and the application portion, wherein
the valve mechanism includes at least two valve mechanisms of an intake valve and a liquid discharge valve,
the intake valve mechanism includes a valve rod and a second valve container,
air is allowed to be intaken through a gap between the valve rod and the second valve container when an inside of the coating liquid tank is at a negative pressure,
the liquid discharge valve mechanism includes the intake valve mechanism and a first valve container, and
a coating liquid is allowed to flow through a gap between the intake valve mechanism and the first valve container when the inside of the coating liquid tank is at a positive pressure.

2. The applicator according to claim 1, wherein
the liquid discharge valve mechanism includes a first spring configured to urge a gap between the second valve container and the first valve container to be closed,
the intake valve mechanism includes a second spring configured to urge a gap between the valve rod and the second valve container to be closed, and
an urging force of the second spring is set to operate at least at atmospheric pressure.

3. The applicator according to claim 1, wherein
the valve mechanism includes the first spring, the second valve container, and the valve rod coaxially disposed in the first valve container.

4. The applicator according to claim 1, wherein
the applicator includes a storage body in the front barrel and has a function of suppressing a flow of a coating liquid discharged from the valve mechanism and suppressing an amount of a coating liquid flowing to the application portion.

5. The applicator according to claim 1, wherein
a stirring rod slidable in a front-rear direction is disposed in front of a coaxial line of the valve rod of the liquid discharge valve mechanism, and
the stirring rod is contactable with the valve rod.
